(19) United States
(12) Patent Application Publication
(10) Pub. No.: US 2015/0013789 A1
(43) Pub. Date: Jan. 15, 2015

(54) FLUID CIRCULATION VALVE

(71) Applicant: Valeo Systemes de Controle Moteur, Cergy Saint Christophe (FR)

(72) Inventors: Grégory Hodebourg, Sartrouville (FR); Samuel Leroux, Poissy (FR)

(21) Appl. No.: 14/382,814

(22) PCT Filed: Feb. 19, 2013
(86) PCT No.: PCT/FR2013/050344

§ 371 Date: Sep. 4, 2014

(30) Foreign Application Priority Data
Mar. 28, 2012 (FR) 1252792

(51) Int. Cl. F02M 25/07; F16K 15/00; F16K 1/22

(52) U.S. Cl. CPC F02M 25/0793; F16K 1/22; F16K 15/00
USPC 137/527

(57) ABSTRACT

The invention relates to a valve (1) for regulating the flow of EGR gases in a loop allowing a proportion of the exhaust gases leaving a vehicle combustion engine to be bled off, having a body delimiting an internal duct (2) and comprising a shutter (3) pivot-mounted on an axle (4) dividing said flap (3) into a first part (5) and a second part (6), said flap (3) being able to pivot between an open position that allows gases to pass into the duct (2) and a closed position that prevents said passage, and for which out of the first (5) and second (6) parts, at least one comes into abutment against a support element (7). The first part (5) of the flap has a thickening (9) so as to reduce the passage section for gases between said first part (5) and the support element (7), for angles of opening of said flap (3) that are below a threshold value.

The invention relates to a fluid circulation valve. This type of valve may for example equip a circuit for supplying gas to a vehicle internal combustion engine to regulate the flow of EGR (Exhaust Gas Recirculation) gases in a loop for bleeding some of the exhaust gases leaving the engine in order to reinject them on the upstream side of said engine. The operating principle of this type of valve relies on the controlled rotation of a flap from a completely open position to allow the fluid to pass to a closed position to prevent it passing. The subject matter of the invention is an improved fluid circulation valve.

Thus a fluid circulation valve includes a flap that is mounted to pivot on an axle that separates the flap into a first portion and a second portion. It should be pointed out that the boundary between the first and second portions of the flap is not necessarily materialized physically. When this flap is in a closed position, the first portion and the second portion of said flap typically each come into contact with a seal of the valve, said seal then acting as an abutment for locating said flap.

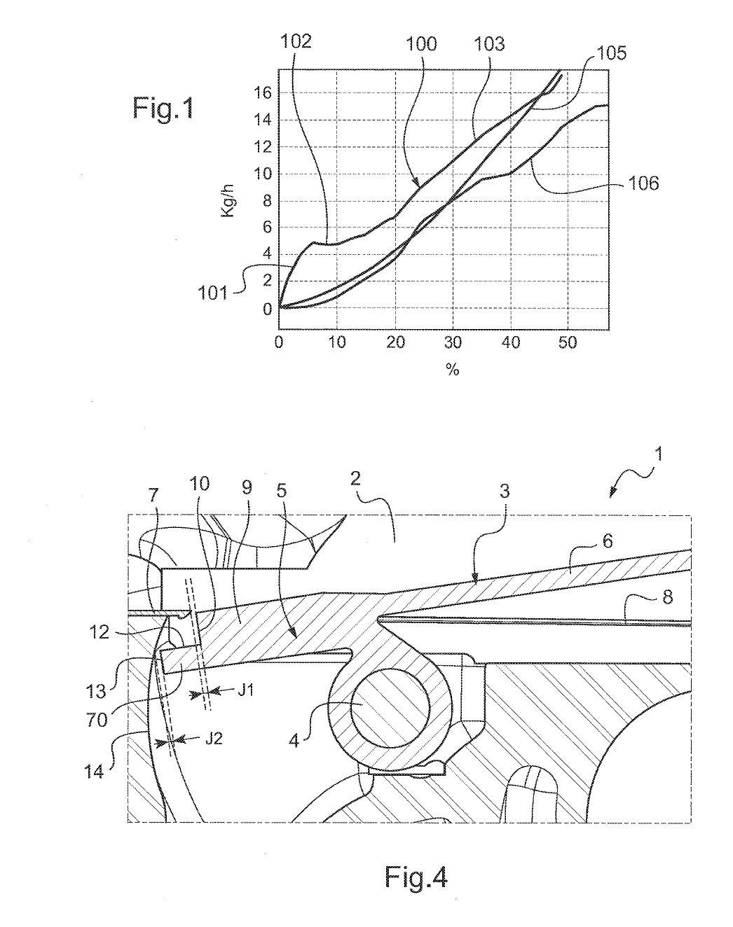

Referring to FIG. 1, which is a diagram showing the mass flow rate of the gases (expressed in kilograms per hour) as a function of the angle of opening of the flap of the valve (expressed as a percentage opening), a problem that is often encountered with this type of valve is that for small angles of opening of the flap the gas flow rate first rises too quickly and is then stagnant for a few moments before increasing regularly again as the angular opening of the flap continues. In fact, the curve 100 showing the mass flow rate of the gases passing through the valve as a function of the angle of opening of the flap shows firstly a very steep first area 101 corresponding to a sudden rise in the flow rate over an angular range between approximately 0° and 5° followed by a second area 102 resembling a plateau and corresponding to an angular range between approximately 5° and 10°, said curve 100 ending in a third area 103 that is approximately linear, indicating a substantially proportional increase of said flow rate as a function of the opening of the flap over an angular range exceeding approximately 10°. The other two curves 105, 106 in the diagram show a linear variation of the mass flow rate of the gases passing through other types of valves as a function of the angle of opening of the flap of said valves and over the whole of the range of possible angular opening of said flap. These two curves show the variation of the gas flow rate that it would be desirable to observe in a valve in accordance with the invention.

A fluid circulation valve in accordance with the invention has a pivoting regulator flap that has undergone a structural modification in order to limit the gas flow rate for small angles of opening of said flap. The flow rate of the gases passing through said valve is therefore linear over the whole of the possible range of angles of opening, thus eliminating the sudden rise in this flow rate observed at very small angles of opening as well as over the phase of stagnation of this flow rate following this sudden rise. A valve in accordance with the invention therefore ensures a progressive increase in the gas flow rate, smoothly and without sudden fluctuations, and therefore offers better control of the gas flow rate than valves equipped with a conventional flap.

The invention consists in a fluid circulation valve having a body delimiting an internal duct and including a flap mounted to pivot on an axle separating said flap into a first portion and a second portion, said flap being adapted to pivot between an open position allowing the passage of the fluid, notably of the gases in the duct, and a closed position preventing said passage, and for which at least one of the first and second portions comes to abut against a bearing member. The first portion of the flap includes a thickened region in order to reduce the gas flow section between said first portion and the bearing member for angles of opening of said flap less than a threshold value. The objective of such a thickened region is to reduce the gas flow section as soon as the flap pivots to open it in order to slow the rise in the gas flow rate in the first moments of opening of said flap and therefore to eliminate the stagnation phase that intervenes at the time of a sudden rise in said flow rate. The rise in the gas flow rate in said valve is therefore regular with no change of slope throughout the phase of opening the valve corresponding to progressive pivoting of the flap from its closed position.

The valve may be a valve for regulating the flow rate of the EGR gases in a loop enabling bleeding of some of the exhausts gases leaving a vehicle internal combustion engine.

The valve may be a valve disposed in the inlet circuit of the internal combustion engine, in the exhaust circuit of the internal combustion engine or in an exhaust gas recirculation loop enabling the latter gases to be reinjected into the inlet of the internal combustion engine. This recirculation loop be a “low-pressure” loop or a “high-pressure” loop.

The valve is notably a so-called “two-port” valve.

Alternatively, the valve may be a so-called “three-port” valve. The valve may then be disposed at the entry of the recirculation loop, i.e. at the location in the exhaust circuit from which the recirculation loop starts. Alternatively, the so-called “three-port” valve may be disposed at the exit of the recirculation loop, i.e. at the location of the inlet circuit in which the exhaust gases are reinjected into the inlet.

The bearing member may consist of a seal of the valve.

The seal may seal the valve at the perimeter of the first and second portions of the flap when the flap is in the closed position. The thickened region is then configured on the first portion of the flap taking account of the position of the seal in the internal structure of the valve.

When this flap is in the closed position, the first portion and the second portion of said flap can each come into contact with the seal of the valve, said seal then acting as an abutment for locating said flap.

When this flap is in the closed position, a first surface of the first portion of the flap may come into contact with the seal of the valve and a second surface of the second portion of the flap may come into contact with the seal of the valve, the first and second surfaces being opposite surfaces of the flap.

The first and second surfaces of the flap may come into contact with the seal while in the same plane.

The first portion of the flap may include a support part on top of which is a thickened region that connects the second portion of the flap to the support part.

The width of the support part measured along the axis of rotation of the flap may be greater than that of the thickened region measured along the rotation axis of the flap.

The contour of the thickened region may be delimited by a rear wall parallel to the axis of rotation of the flap and by two parallel lateral walls extending in a direction perpendicular to said axis of rotation, said three walls being perpendicular to the surface plane of the support part.

The thickened region may have any shape and its main function is to increase the dimensions of the first portion of the flap in at least one direction.

The thickened region may either consist in an added part fastened to the first portion of the flap or be manufactured with said first portion so as to be in one piece with it.

Generally speaking, the small angles of opening of the flap correspond to the first few degrees of opening of said flap.

The threshold value is advantageously less than 10°. The behavior of the flap is generally critical in relation to the gas flow rate for angles of opening less than 10°. It is over this range of angles from 0 to 10° that a rapid rise in the gas flow rate may be observed, followed by a phase of stagnation of said flow rate.

The thickened region preferably extends the whole width of the first portion of the flap, the width of said first portion being parallel to the axis of rotation of the flap. For this configuration, the thickened region occupies a spread out position on the first portion of the flap and can therefore completely fulfill its role of flow rate regulator through cooperation with the seal of the internal structure of the valve.

The first portion of the flap is advantageously a thin portion, the thickened region contributing to increasing the thickness of said first portion.

The thickened region is preferably configured to provide a constant gas flow section over a range of angles of opening less than 10°. In this way, the geometry of the thickened region is designed taking into account the position and the shape of the seal to define in conjunction with said seal a passage of constant section with the aim of ensuring a constant gas flow rate over a range of angles of opening of less than 10°.

The constant flow section is advantageously achieved by means of a plane wall of the thickened region. In other words, this plane wall can move on rotation of the flap, remaining parallel to its surface plane and remaining at a constant distance from said seal. Thanks to this wall, the gas flow rate over a range of small angles of opening of the flap can remain constant.

The first portion of the flap is preferably substantially plane, the plane wall of the thickened region that enables a constant gas flow rate to be achieved being substantially perpendicular to the plane of said first portion. This is a structural feature of the thickened region enabling a small and constant gas flow section to be achieved over a range of small angles of opening of the flap.

The two portions of the flap are advantageously continuous with each other and rigidly connected to each other. In other words, the two portions of the flap pivot simultaneously to open or close the valve.

The rear edge of the first portion of the flap, which constitutes the edge at the greatest distance from the rotation axis, preferably forms with an area of the internal structure of the valve a second gas passage. In this way, the gas flow rate through the valve is regulated in two ways: on the one hand, thanks to the thickened region that limits the gas flow for small angles of opening of the flap and, on the other hand, thanks to the position of the first portion of the flap relative to the internal structure of the valve, which provides a second passage for gases that have already passed between the thickened region and the seal.

The aforementioned area of the internal structure of the valve is advantageously a cast part, the gas flow rate for small angles of opening of the flap being regulated firstly by the thickened region, which in conjunction with the seal reduces the gas flow section, and then by the rear edge of the first portion of the flap, which in conjunction with said cast portion defines a second passage of constant section throughout the opening travel of the flap.

The bearing member may project into the internal duct of the valve.

Valves in accordance with the invention have the advantage of offering good control of the gas flow rate throughout the range of opening of the valve, notably offering a linear and regular rise in the gas flow rate over a reduced range of angles of opening of the flap. Valves in accordance with the invention have the advantage of offering better performance than existing regulator valves thanks to this improved control of the gas flow rate whilst remaining of constant overall size and easy to manufacture. They have the advantage of being of relatively low cost in that the valve is modified by adding a material that is commonly used and of relatively low cost.

A detailed description of a preferred embodiment of a valve in accordance with the invention is given hereinafter with reference to the appended drawings, in which:

FIG. 1, already described, is a diagram showing the mass flow rate of the gases passing through a prior art regulator valve as a function of the angle of opening of its flap,

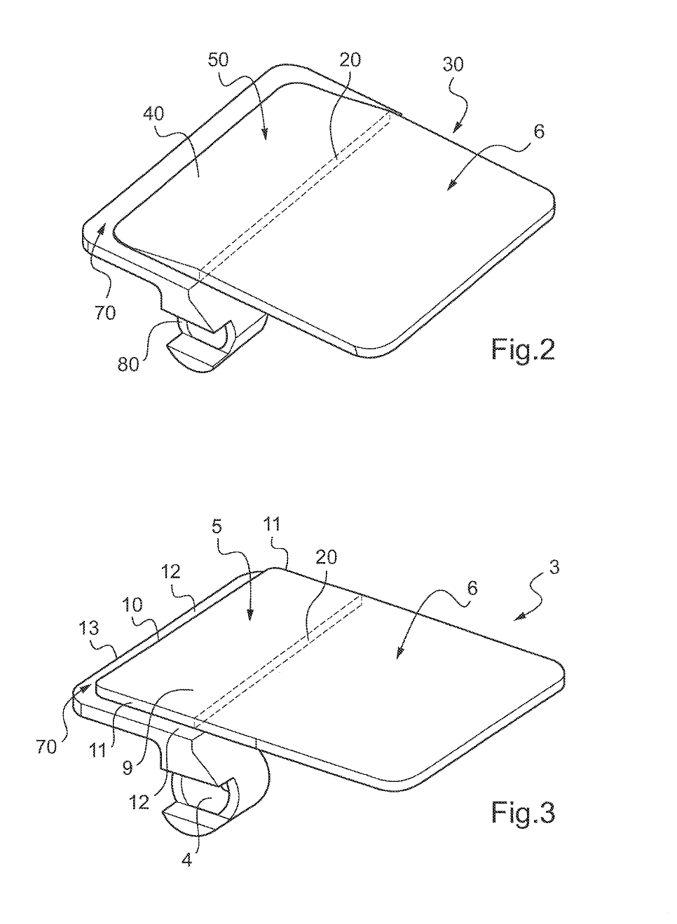

FIG. 2 is a perspective view of a flap of a prior art valve,

FIG. 3 is a perspective view of a flap of a valve in accordance with the invention,

FIG. 4 is a diagrammatic view of the internal structure of a fluid circulation valve in accordance with the invention, the flap being slightly open.

A gas circuit of a motor vehicle internal combustion engine comprises an upstream portion supplying said engine with gas, notably in which cool air circulates, and a downstream exhaust portion in which burned gases circulate to be evacuated from the vehicle. Such a gas circuit generally includes at least one EGR (Exhaust Gas Recirculation) loop connecting the downstream exhaust portion to the upstream supply portion to enable exhaust gases to be mixed with the incoming cool air. Because these EGR loops must not be open at all times in all phases of operation of the engine, each is equipped with an EGR valve for regulating the flow of exhaust gases circulating in the loop concerned.

Referring to FIG. 4, an EGR valve 1 in accordance with the invention includes a gas circulation duct 2 and a flap 3 mounted to pivot on an axle 4 and adapted to move between a closed position in which it prevents the passage of the exhaust gases and an open position in which it allows that passage. The flap 3 is mounted on the axle 4 in such a way that said axle 4 separates said flap 3 into a first portion 5 and a second portion 6. Said portions 5, 6 are plane and thin and are continuous with each other. They preferably constitute a single part. These two portions 5, 6 may have exactly the same width, said width then constituting their dimension along the axle 4, while the first portion 5 has a length less than that of the second portion 6, their length representing their dimension along an axis perpendicular to said axle 4. The first portion 5 and the second portion 6 are at 180° to each other and rigidly connected to each other so that they pivot simultaneously about the axle 4. When the flap 3 is in the closed position, the first portion 5 comes to bear against a first portion of a seal 7 and the second portion 6 can come to bear against a second seal portion 8. Alternatively, a clearance of a few tenths of a millimeter may be provided between the second portion 6 and the second seal portion 8 so that the system remains isostatic. The seal 7, 8 is mounted in the valve 1. The two seal portions 7, 8 may be continuous with each other, in the same plane, and when the flap 3 is in the completely closed position the first portion 5 comes to bear against a face of the first seal portion 7 while the second portion 6 comes to bear against the opposite face of the second seal portion 8 (or with the clearance referred to in connection with the aforementioned variant). The arrangement of the flap 3 in the valve 1 is such that the first portion 5 of the flap controls the entry of the gases and the second portion 6 of said flap 3 controls the exit of said gases.

Referring to FIG. 2, a flap 30 of a prior art valve includes a rectangular second portion 6 having a constant thickness. The first portion 50 of this flap 30 includes a substantially rectangular support part 70 of constant thickness surmounted by a substantially rectangular connecting part 40 having a profiled thickness, said connecting part 40 connecting the second portion 6 of the flap 30 to the support part 70. In fact, this connecting part 40 in contact with the support part 70 ideally extends the second portion 6 of the flap 30, having the same thickness at their joining plane 20, the thickness of this connecting part 40 decreasing progressively away from said joining plane 20 in a direction perpendicular to this plane 20. It should be pointed out that the joining plane 20 is parallel to the axle 80 of the flap 30. The dimensions of the support part 70 are greater than those of the connecting part 40 in contact with it so that the thickness of the U-shaped peripheral portion of the first portion 50 of the flap 30 corresponds to the thickness of this support part 70. The second portion 6 of the flap 30 and the connecting part 40 preferably constitute a single part. This type of flap 30 yields the profile 101 in the FIG. 1 diagram corresponding to a sudden rise 102 of the gas flow rate for angles of opening less than 5° followed by a phase 103 of stagnation of this flow rate for angles of opening between 5° and 10°.

Referring to FIG. 3, a flap 3 of a valve 1 in accordance with the invention differs from the flap 30 of the prior are valve described above at the level of their first portion 5, 50. In fact, the connecting part is a thickened region 9 that extends the second portion 6 of the flap 3, is in contact with the support part 70 of the first portion 5 and no longer has a profiled thickness but a constant thickness. The new constant thickness of this thickened region 9 corresponds to the thickness of the second portion 6 of the flap. In this way, the thickened region 9 of constant thickness and the second portion 6 of the flap 3 may constitute a single part of rectangular parallelepiped shape. In other words, in a more global manner, the first portion 5 of a flap 3 of a regulator valve 1 in accordance with the invention is raised relative to the first portion 50 of a flap 30 of a prior art valve. All the other structural features of the flap 3, 30 remain unchanged. It is important to emphasize that the contour of the thickened region 9 is delimited by a rear wall 10 parallel to the axle 4 and by two parallel lateral walls 11 extending in a direction perpendicular to said axle 4, said three walls 10, 11 being perpendicular to the surface plane 12 of the support part 70.

When the flap 3 of a regulator vale 1 in accordance with the invention is in the fully closed position, the second portion 6 of said flap 3 is in contact with the second seal portion 8 and the surface 12 of the support part 70 of the first portion 5 of said flap 3 is in contact with the first seal portion 7. Referring to FIG. 4, showing the flap 3 in a slightly open position corresponding to an angle of rotation less than 10°, the thickened region 9 of the first portion 5 of the flap 3 produces a gas flow section J1 that is small and constant over a travel of the flap 3 corresponding to a rotation of 0° to approximately 10°. This constant flow section J1 is made possible by the rear wall 10 of this thickened region 9 which, during this small rotation, moves in a plane that is parallel to its surface plane, thus maintaining a constant distance from the first seal portion 7. Beyond a rotation of 10°, the section of this passage increases progressively to ensure a linear gas flow rate over the rest of the travel of the flap 3 to the fully open position. The rear edge 13 of the support part 70 of the first portion 5 of the flap 3, which is an edge parallel to the axle 4 of the flap 3 and constitutes the edge 13 of said part 70 at the greatest distance from said axle 4, produces in conjunction with a cast wall 14 of the internal structure of a valve 1 in accordance with the invention a second gas passage J2, this second passage J2 retaining a substantially constant section throughout the opening travel of the valve. In this way, when the flap 3 of a valve 1 in accordance with the invention opens from its fully closed position, the mass flow rate of the gases through said valve 1 is regulated firstly thanks to the narrow first passage J1 formed between the thickened region 9 of the first portion 5 of the flap 3 and the first seal portion 7 and then thanks to the second passage J2 formed between the support part 70 of said first portion 5 of the flap 3 and a cast wall 14 of the internal structure of the valve 1. A flap 3 of a regulator valve 1 in accordance with the invention enables a mass flow rate of the gases to be achieved that is linear over the entire opening travel of said flap 3 between its closed position and its open position.

Variant embodiments may be produced without departing from the scope of the invention. In particular, the seals or seal portions 7, 8 referred to here are one example of a bearing element with which the thickened region 9 may cooperate. Another part, such as a cast part or an attached support, can fulfill the same function.

1. A valve for regulating the flow of the EGR gases in a loop enabling bleeding of some of the exhaust gases leaving a vehicle internal combustion engine, the valve comprising:
a body delimiting an internal duct and including a flap mounted to pivot on an axle separating said flap into a first portion and a second portion, said flap being able to pivot between an open position allowing the passage of the gases in the duct and a closed position preventing said passage, and for which the first portion and the second portion come(s) to abut against a bearing element, the first portion of the flap including a thickened region in order to reduce the gas flow section between said first portion and the bearing element for angles of opening of said flap less than a threshold value.

2. The valve as claimed in claim 1, the threshold value being less than 10°.

3. The valve as claimed in claim 1, the bearing element being a seal of the valve, the seal sealing the valve at the perimeter of the first portion and the second portion of the flap when the valve is in the closed position.

4. The valve as claimed in claim 3, a first surface of the first portion of the flap coming into contact with the seal of the valve and a second surface of the second portion of the valve coming into contact with the seal of the valve when the flap is in a closed position, wherein the first and second surfaces are on opposite surfaces of the flap.

5. The valve as claimed in claim 1, the thickened region extending the entire width of the first portion of the flap, the width of said first portion being parallel to the axle of the flap.

6. The valve as claimed in claim 5, the first portion of the valve including a support part surmounted by the thickened region that connects the second portion of the flap to the support part.

7. The valve as claimed in claim 6, the width of the support part measured along the rotation axis of the flap being greater than that of the thickened region measured along the rotation axis of the flap.

8. The valve as claimed in claim 1, the thickened region being configured to produce a constant gas flow section over a range of angles of opening less than 10°.

9. The valve as claimed in claim 8, the constant flow section being produced by a plane wall of the thickened region.

10. The valve as claimed in claim 9, the first portion of the flap being substantially planar and the plane wall of the thickened region enabling a constant gas flow section to be produced is substantially perpendicular to the plane of said first portion.

11. The valve as claimed in claim 1, the two portions of the flap being continuous with each other and rigidly connected to each other.

12. The valve as claimed in claim 1, a rear edge of the first portion of the flap that constitutes the edge at the greatest distance from the axle producing in conjunction with a wall of the internal structure of the valve a second passage for the gases.

13. The valve as claimed in claim 12, the wall of the internal structure of the valve being a cast wall and the gas flow rate for small angles of opening of the flap being regulated firstly by the thickened region that in conjunction with the first seal portion reduces the gas flow section and then by the rear edge of the first portion of the flap that in conjunction with said cast wall produces a constant second flow section throughout the opening travel of the flap.

14. The valve as claimed in claim 1, wherein the bearing element projects into the internal duct of the valve.
